(19) United States
(12) Patent Application Publication
(10) Pub. No.: US 2020/0049524 A1
(43) Pub. Date: Feb. 13, 2020

(54) TRAVEL ROUTE ESTIMATION APPARATUS AND TRAVEL ROUTE ESTIMATION METHOD

(71) Applicant: MITSUBISHI ELECTRIC CORPORATION, Tokyo (JP)

(72) Inventors: Yuko OTA, Tokyo (JP); Masahiko IKAWA, Tokyo (JP); Ryusuke KINOSHITA, Tokyo (JP)

(73) Assignee: MITSUBISHI ELECTRIC CORPORATION, Tokyo (JP)

(21) Appl. No.: 16/340,628

(22) PCT Filed: Oct. 25, 2016
(86) PCT No.: PCT/JP2016/081558

§ 371 Date: Apr. 9, 2019

(51) Int. Cl. G01C 21/34; G08G 1/0968

(52) U.S. Cl. CPC G01C 21/3484; H04W 4/44; G08G 1/096805

(57) ABSTRACT

It is an object of the present invention to provide a technique to make it possible to estimate a travel route even if no destination is set or estimated. A travel route estimation apparatus includes an acquisition unit and a route estimation unit. The acquisition unit acquires an estimated destination which is estimated as a destination of a vehicle, a current position of the vehicle, and a travel history of the vehicle. When the acquisition unit does not acquire the estimated destination, the route estimation unit estimates a travel route which the vehicle travels from the current position, on the basis of the current position and the travel history which are acquired by the acquisition unit.

### TECHNICAL FIELD

The present invention relates to a travel route estimation apparatus for estimating a travel route which a vehicle travels.

### BACKGROUND ART

Techniques for estimating a destination even in a case where a user does not set a destination of his vehicle have been proposed. A technique disclosed in Patent Document 1, for example, comprises (1) a current position acquisition means, (2) a destination estimation means for estimating a destination which a vehicle heads for, (3) an estimated route search means for searching for an estimated route to the destination or its surroundings, (4) a traffic information acquisition means for acquiring traffic information of the estimated route and its surroundings, (5) a minimum-time route search means for searching for a minimum-time route based on the traffic information, (6) a route comparison means for comparing the estimated route with the minimum-time route, and (7) a route information output means for outputting route information on both the routes when these routes do not coincide with each other.

### PRIOR ART DOCUMENTS

### Patent Documents

[Patent Document 1] Patent Publication No. 4289091

### SUMMARY

### Problem to be Solved by the Invention

According to the above-described technique, the destination of a user is estimated on the basis of a current position, current time, a travel locus, and the like, and when one or more destinations are estimated, estimated routes leading to the destinations are extracted from past travel routes. In this technique, however, there is a problem that no travel route can be estimated unless a destination is set or estimated.

Then, the present invention is intended to solve such a problem as above, and it is an object of the present invention to provide a technique to make it possible to estimate a travel route even if no destination is set or estimated.

### Means to Solve the Problem

The present invention is intended for a travel route estimation apparatus. According to the present invention, the travel route estimation apparatus includes an acquisition unit for acquiring an estimated destination which is estimated as a destination of a vehicle, a current position of the vehicle, and a travel history of the vehicle and a route estimation unit for estimating a travel route which the vehicle travels from the current position, on the basis of the current position and the travel history which are acquired by the acquisition unit, when the acquisition unit does not acquire the estimated destination.

### Effects of the Invention

According to the present invention, when the estimated destination is not acquired, a travel route which the vehicle travels from the current position is estimated on the basis of the current position and the travel history which are acquired. It is thereby possible to estimate the travel route even if no destination is set or estimated.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing a constitution of a travel route estimation apparatus in accordance with a first preferred embodiment;

FIG. 2 is a block diagram showing a constitution of a travel route estimation apparatus in accordance with a second preferred embodiment;

FIG. 3 is a flowchart showing an operation of the travel route estimation apparatus in accordance with the second preferred embodiment;

FIG. 4 is a flowchart showing another operation of the travel route estimation apparatus in accordance with the second preferred embodiment;

FIG. 5 is a view illustrating the operation of the travel route estimation apparatus in accordance with the second preferred embodiment;

FIG. 6 is a block diagram showing a hardware constitution of a navigation device in accordance with other variations;

FIG. 7 is a block diagram showing another hardware constitution of the navigation device in accordance with other variations;

FIG. 8 is a block diagram showing a constitution of a server in accordance with other variations; and

FIG. 9 is a block diagram showing a constitution of a communication terminal in accordance with other variations.

### DESCRIPTION OF EMBODIMENT(S)

<The First Preferred Embodiment>

Hereinafter, a vehicle on which a travel route estimation apparatus in accordance with the first preferred embodiment of the present invention is mounted, to which attention is paid, will be referred to as a “subject vehicle” in the following description. Further, the travel route estimation apparatus is applied to, for example, a navigation device or the like.

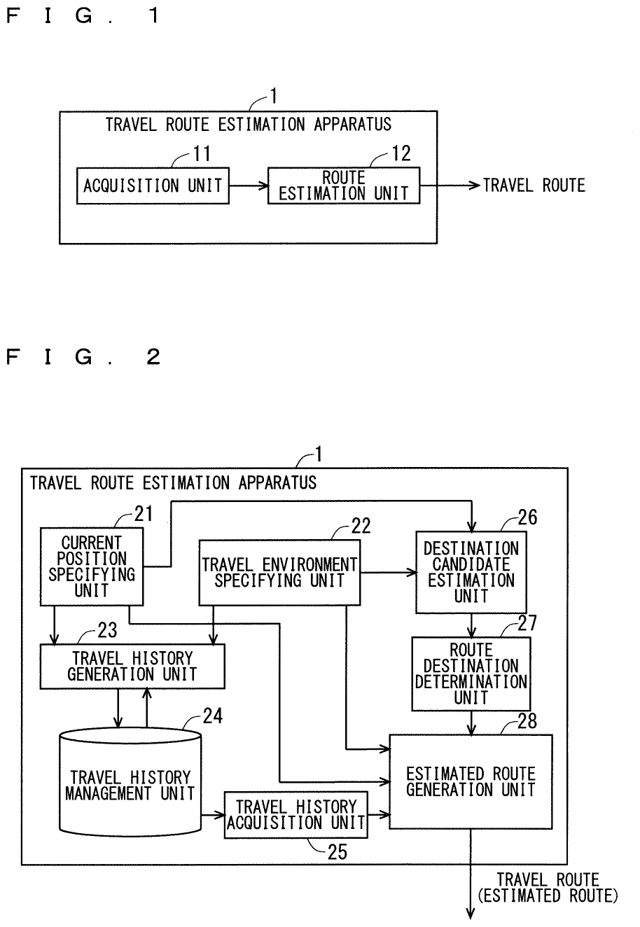

FIG. 1 is a block diagram showing a constitution of a travel route estimation apparatus 1 in accordance with the first preferred embodiment. The travel route estimation apparatus 1 shown in FIG. 1 comprises an acquisition unit 11 and a route estimation unit 12.

The acquisition unit 11 acquires an estimated destination which is estimated as a destination of the subject vehicle and a current position of the subject vehicle, and a travel history of the subject vehicle.

Acquisition performed by the acquisition unit 11 includes various operations. For example, the acquisition unit 11 may acquire an estimated destination which is estimated by an external device outside the travel route estimation apparatus 1 from the external device, or may estimate an estimated destination by itself. For example, the acquisition unit 11 may acquire a current position detected by an external device, from the external device, or may detect a current position by itself. For example, the acquisition unit 11 may acquire a travel history from an external device, or may acquire a travel history accumulated in the travel route estimation apparatus 1.

When the acquisition unit 11 does not acquire any estimated destination, the route estimation unit 12 estimates a travel route which the subject vehicle travels from the current position, on the basis of the current position and the travel history which are acquired by the acquisition unit 11. On the other hand, when the acquisition unit 11 acquires an estimated destination, the route estimation unit 12 estimates a travel route which the subject vehicle travels from the current position to the estimated destination, on the basis of the estimated destination, the current position and the travel history which are acquired by the acquisition unit 11. When the acquisition unit 11 acquires a destination from a user or the like, the route estimation unit 12 estimates a travel route which the subject vehicle travels from the current position to the destination, on the basis of the destination, the current position and the travel history which are acquired by the acquisition unit 11, regardless of whether or not the acquisition unit 11 acquires the estimated destination.

<Gist of The First Preferred Embodiment>

By the travel route estimation apparatus 1 in accordance with the above-described first preferred embodiment, even if no estimated destination can be acquired, the travel route can be estimated by using the travel history. It is thereby possible to predict a route which the subject vehicle travels by driver's driving with relatively high probability.

Further, in the first preferred embodiment, when the estimated destination can be acquired, the travel route which the subject vehicle travels from the current position to the estimated destination is estimated by using the estimated destination and the travel history. Since estimated time of arrival to the estimated destination or the like can be thereby calculated, it is possible to achieve highly sophisticated travel support.

<The Second Preferred Embodiment>

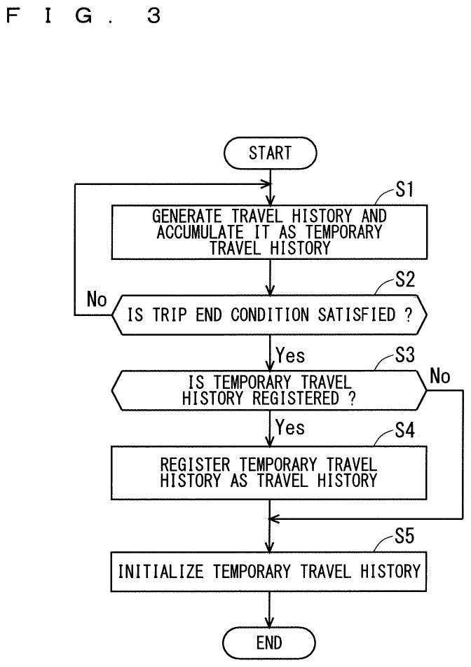

FIG. 2 is a block diagram showing a constitution of a travel route estimation apparatus 1 in accordance with the second preferred embodiment. Hereinafter, among constituent elements described in the second preferred embodiment, the constituent elements identical to or similar to those in the first preferred embodiment will be represented by the same reference signs and different constituent elements will be mainly described.

The travel route estimation apparatus 1 shown in FIG. 2 comprises a current position specifying unit 21, a travel environment specifying unit 22, a travel history generation unit 23, a travel history management unit 24, a travel history acquisition unit 25, a destination candidate estimation unit 26, a route destination determination unit 27, and an estimated route generation unit 28. Further, the current position specifying unit 21, the travel environment specifying unit 22, the travel history generation unit 23, the travel history management unit 24, the travel history acquisition unit 25, the destination candidate estimation unit 26, and the route destination determination unit 27 correspond to the acquisition unit 11 described in the first preferred embodiment. The estimated route generation unit 28 corresponds to the route estimation unit 12 described in the first preferred embodiment.

Hereinafter, the constituent elements of the travel route estimation apparatus 1 in accordance with the second preferred embodiment will be described in detail.

The current position specifying unit 21 specifies information of the current position of the subject vehicle on the map. As the information of the current position, for example, used are information of road link, information of longitude and latitude, and information indicating a rectangular area obtained by dividing the map, and the like on which the subject vehicle is currently present. Further, the information of road link is information indicating a road network formed of nodes and links.

As this current position specifying unit 21, for example, a GPS (Global Positioning System) may be used. Further, as the current position specifying unit 21, for example, a device for performing matching by using speed information or acceleration information of the subject vehicle and map information may be used, or a communication device for acquiring the current position detected by the external device, from the external device may be used.

The travel environment specifying unit 22 acquires travel environment information indicating a travel state of the subject vehicle, including day and time and a vehicle condition of the vehicle. In the following description, the travel environment information indicating the current travel state of the subject vehicle will be sometimes referred to as “current state information” and the travel environment information indicating the past travel state of the subject vehicle will be sometimes referred to as “past state information”.

In the second preferred embodiment, the travel environment specifying unit 22 acquires the current state information from various sensors, the communication device, and the like. For example, the travel environment specifying unit 22 acquires information of month and date, time, day of week, the number of passengers, and the like during travel of the subject vehicle, as the current state information which is travel environment information. Further, the travel environment specifying unit 22 may also acquire information of outside temperature, weather, traffic conditions, and the like during travel of the subject vehicle, as the current state information.

The travel history generation unit 23 generates the travel history including a position of the subject vehicle at each time during a trip and a position of the subject vehicle at the end of trip, on the basis of the information of current position acquired by the current position specifying unit 21 and the current state information acquired by the travel environment specifying unit 22. The “trip” refers to a series of travels of the subject vehicle from when the subject vehicle starts traveling to when the subject vehicle finishes traveling. In the following description, the position of the subject vehicle at the end of trip will be referred to as a “trip end position”.

As a position of the subject vehicle at each time, which is included in the travel history, for example, used are the information of road link and the like on which the subject vehicle is currently present, as well as the current position of the subject vehicle. As the trip end position included in the travel history, for example, the information of longitude and latitude and the like may be used, or a location information ID defined by the user or a system, and the like, may be used.

The travel history generation unit 23 adds the current state information which is the travel environment information acquired by the travel environment specifying unit 22 to the travel history as necessary. The travel history generated by the travel history generation unit 23 is stored and managed by the travel history management unit 24. At that time, the travel environment information added to the travel history is stored in the travel history management unit 24 as the past state information.

The travel history management unit 24 manages the travel history generated by the travel history generation unit 23, as an intersection history.

The intersection history is information including the frequency of advances of an advance destination to which the subject vehicle advanced immediately afterward from the intersection in the past for each intersection which is predetermined on the map. Further, when the number of advances is the total number of times for registrations, the frequency of advances is the number of times for registrations per unit time period. Assuming that the unit time period is a data collection period, this frequency of advances can be defined as a numerical value obtained by dividing the number of times for registrations within the data collection period by the data collection period. The data collection period may be fixed, may be changed according to the number of registrations corresponding to the number of times for registrations of the travel history, or may be changed for each intersection according to the number of registrations of the travel history for each intersection. When the data collection period is changed for each intersection according to the number of registrations of the travel history for each intersection, for example, the frequency of advances at an intersection where the number of travels is less can be calculated as the average number of advances for one month by using the travel history for the latest six months, and the frequency of advances at an intersection where the number of travels is more can be calculated as the average number of advances for one month by using the travel history for the latest two months.

In the second preferred embodiment, management is performed so that the intersection history should be determined when an intersection and an approach direction at the time when the subject vehicle approached the intersection in the past are determined. It is assumed, for example, that in a case where the travel history is managed by using the information of road link, one link and one approach direction are determined. In this case, with one intersection which the vehicle first approaches when tracing the one link in the one approach direction and the one approach direction as a key, the intersection history for each link connected to the one intersection can be acquired. Further, in a case where the travel history is managed by using intersection coordinates information, for example, when coordinates of one intersection and one approach bearing are determined, with the one intersection and one approach direction corresponding to the one approach bearing as a key, an intersection history for each link connected to the intersection at the position can be acquired. Furthermore, the approach direction may be obtained from the position of the subject vehicle at each time, or may be acquired from various sensors and the communication device, and the like.

The above-described travel history management unit 24 manages the travel history generated by the travel history generation unit 23 also as a candidate for the estimated destination.

The candidate for the estimated destination is a position where the number of acquisitions as the trip end position is one or not less than a predetermined number. As the candidate for the estimated destination, the information of longitude and latitude or the like may be used, or the POI (Point of Interest) of the map, a registration point of the user, and the like, may be used.

The travel history acquisition unit 25 acquires, as appropriate, the travel history such as the intersection history and the past state information which is the travel environment information added to the travel history from the travel history management unit 24 and outputs these information to the estimated route generation unit 28.

The destination candidate estimation unit 26 estimates a destination which the subject vehicle heads for, in accordance with a specific rule, on the basis of the information of current position acquired by the current position specifying unit 21 and the current state information which is the travel environment information acquired by the travel environment specifying unit 22. The destination candidate estimation unit 26 performs this estimation, to thereby acquire a candidate for the estimated destination which is the same as the candidate for the estimated destination managed by the travel history management unit 24. The destination candidate estimation unit 26 sometimes acquires a plurality of candidates for the estimated destination, depending on the estimation result.

Further, when the destination candidate estimation unit 26 acquires the candidate for the estimated destination, the destination candidate estimation unit 26 also generates reliability indicating the degree of possibility that the candidate for the estimated destination is a destination which the driver intends to head for. As the reliability, for example, used is the number of times that the candidate for the estimated destination are acquired as the trip end position, or the like.

The route destination determination unit 27 acquires one estimated destination on the basis of the candidate for the estimated destination and the reliability thereof which are acquired by the destination candidate estimation unit 26. As described later in detail, depending on the candidate for the estimated destination and the reliability thereof which are acquired by the destination candidate estimation unit 26, the route destination determination unit 27 sometimes does not acquire the estimated destination.

When the route destination determination unit 27 acquires the estimated destination, the estimated route generation unit 28 estimates a travel route which the subject vehicle travels from the current position to the estimated destination, on the basis of the estimated destination acquired by the route destination determination unit 27, the current position acquired by the current position specifying unit 21, and the travel history acquired by the travel history acquisition unit 25. In the second preferred embodiment, the estimated route generation unit 28 estimates the travel route by using only the history that the subject vehicle travels to the estimated destination, among the travel history acquired by the travel history acquisition unit 25.

On the other hand, when the route destination determination unit 27 does not acquire the estimated destination, the estimated route generation unit 28 estimates a travel route which the subject vehicle travels from the current position to the estimated destination, on the basis of the current position acquired by the current position specifying unit 21 and the travel history acquired by the travel history acquisition unit 25. In the second preferred embodiment, the estimated route generation unit 28 estimates the travel route by using all the travel history acquired by the travel history acquisition unit 25. In the following description, the travel route estimated by the estimated route generation unit 28 is sometimes referred to as an “estimated route”.

<Operation>

The operation of the travel route estimation apparatus 1 in accordance with the second preferred embodiment is broadly divided into a travel history accumulation process performed by the travel history generation unit 23 and the like and a route estimation process performed by the estimated route generation unit 28 and the like.

FIG. 3 is a flowchart showing the travel history accumulation process from the start of travel of the subject vehicle until the travel history is registered in the travel history management unit 24. This process is performed repeatedly in succession while the system is running. By performing this process, the intersection history is accumulated at any time during the trip and the candidate for the estimated destination is accumulated for each trip. Hereinafter, the travel history accumulation process will be described, assuming that the travel history is managed by the information of road link. Further, even when the travel history is managed by the information of road link, for example, the travel history accumulation process can be performed in the same manner as the process described below.

In Step S1, first, after the subject vehicle starts traveling, the travel history generation unit 23 generates the travel history in the current trip, on the basis of the current position acquired by the current position specifying unit 21 and the current state information which is the travel environment information specified by the travel environment specifying unit 22. The travel history includes, for example, the road link corresponding to a position of the subject vehicle at each time. Further, to the travel history, added is the current state information including the month and date, the time, the day of week, the number of passengers, and the like for the time while the subject vehicle travels.

The travel history generated by the travel history generation unit 23 is accumulated in the travel history management unit 24 as a temporary travel history and the travel environment information added to the travel history is also accumulated.

In Step S2, the travel history generation unit 23 determines whether the trip end condition is satisfied or not. As the trip end condition, for example, used are conditions on the stoppage time, the stop position, the number of passengers, and the like of the subject vehicle. For example, in a case where the stoppage time of the subject vehicle is not shorter than a predetermined time, where the stop position of the subject vehicle is a parking lot, where the number of passengers of the subject vehicle is zero, or the like case, it is determined that the trip end condition is satisfied. When it is determined that the trip end condition is satisfied, the process goes to Step S3. When it is not determined that the trip end condition is satisfied, in other words, when the trip continues, the process goes back to Step S1.

In Step S3, the travel history generation unit 23 determines whether to register the temporary travel history as the travel history in the travel history management unit 24. For example, in a case where a travel distance in the trip which is finished, the distance between the trip start position and the trip end position, or the like is not shorter than a predetermined distance, or the like case, it is determined that the temporary travel history should be registered in the travel history management unit 24. When it is determined that the temporary travel history should be registered in the travel history management unit 24, the process goes to Step S4, and when it is not determined that the temporary travel history should be registered in the travel history management unit 24, the process goes to Step S5.

In Step S4, the travel history management unit 24 registers the temporary travel history therein as the travel history and also registers the travel environment information added to the temporary travel history therein as the past state information. At that time, the travel history management unit 24 registers therein the temporary travel history associated with the candidate for the estimated destination. As the candidate for the estimated destination, the latest trip end position itself may be used, or a POI in the vicinity of the latest trip end position may be used. Further, when a distance between the candidate for the estimated destination which has been already registered in the travel history management unit 24 and the latest trip end position is not longer than a certain distance, the travel history management unit 24 may regard the latest trip end position as the candidate for the estimated destination which has been already registered.

In Step S5, in order to accumulate the temporary travel history for the next trip, the temporary travel history is initialized. In other words, the usage of memory is reduced. After that, the process shown in FIG. 3 is ended.

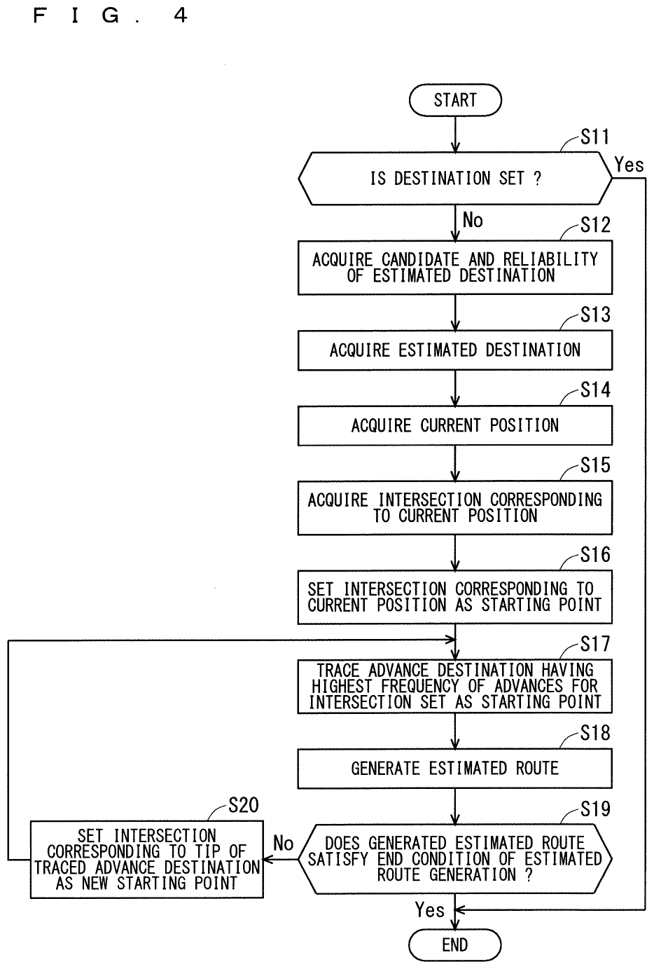

FIG. 4 is a flowchart showing the route estimation process in which a route which the subject vehicle is predicted to travel from now on is estimated. This process is performed as appropriate not only when the travel route estimation apparatus 1 starts up but also in a case where the subject vehicle gets out of the estimated route, a case where the candidate for the estimated destination is changed, a case where a route having high priority is changed by deleting a guidance route which has been used for guidance of the subject vehicle, or the like case.

In Step S11, first, the destination candidate estimation unit 26 determines whether the destination is set or not. For example, when the user automatically or manually sets the destination by using a not-shown destination setting function, or when a route having relatively high priority is already produced by a not-shown route search function, or the like, it is determined that the destination is set. When it is determined that the destination is set, the process shown in FIG. 4 is ended. When it is not determined that the destination is set, the process goes to Step S12.

In Step S12, the destination candidate estimation unit 26 acquires the candidate for the estimated destination and the reliability thereof in accordance with the specific rule, on the basis of the information of current position acquired by the current position specifying unit 21 and the current state information which is the travel environment information acquired by the travel environment specifying unit 22.

In Step S13, the route destination determination unit 27 acquires one estimated destination on the basis of the candidate for the estimated destination and the reliability thereof which are acquired by the destination candidate estimation unit 26. In the second preferred embodiment, when the destination candidate estimation unit 26 acquires a plurality of candidates for the estimated destination, the route destination determination unit 27 determines whether or not a difference between the first reliability which is the highest reliability among the reliabilities of the plurality of the candidates for the estimated destination and the second reliability which is the second highest reliability next to the first reliability among the reliabilities of the plurality of candidates for the estimated destination is not smaller than a predetermined value.

Then, when the route destination determination unit 27 determines that the difference between the first reliability and the second reliability is not smaller than the predetermined value, the route destination determination unit 27 acquires the candidate for the estimated destination having the first reliability as the estimated destination. On the other hand, when the route destination determination unit 27 determines that the difference between the first reliability and the second reliability is smaller than the predetermined value, the route destination determination unit 27 determines that there is no estimated destination.

Further, acquisition of the estimated destination is not limited to the above-described case. For example, when the route destination determination unit 27 determines that the first reliability is not smaller than a predetermined value, the route destination determination unit 27 may acquire the candidate for the estimated destination having the first reliability as the estimated destination. Further, when the route destination determination unit 27 determines that the first reliability is not smaller than a predetermined value and that the difference between the first reliability and the second reliability is not smaller than a predetermined value, the route destination determination unit 27 may acquire the candidate for the estimated destination having the first reliability as the estimated destination.

There is a slight difference in the process consisting of Steps S14 to S20 between in the case where the route destination determination unit 27 acquires one estimated destination in Step S13 and in the case where the route destination determination unit 27 does not acquire any estimated destination. Then, hereinafter, description will be made separately for these two cases.

<Case Where One Estimated Destination is Not Acquired>

In Step S14, first, the estimated route generation unit 28 acquires the current position from the current position specifying unit 21.

In Step S15, the estimated route generation unit 28 acquires an intersection corresponding to the current position acquired by the current position specifying unit 21, by using the map and the like. Though an intersection which the subject vehicle first approaches when the subject vehicle traces the link corresponding to the current position from the current position in a travelling direction is applied to the intersection corresponding to the current position, this is only one exemplary case. In the exemplary case shown in FIG. 5, when tracing a link 32a where a subject vehicle 31 is currently present in the travelling direction, the subject vehicle 31 first approaches an intersection 33a. In this case, the intersection corresponding to the current position acquired by the current position specifying unit 21 is the intersection 33a.

In Step S16, the estimated route generation unit 28 sets the intersection corresponding to the current position as a starting point.

In Step S17, the estimated route generation unit 28 traces a link which is an advance destination having the highest frequency of advances for the intersection set as the starting point. As shown in FIG. 5, in a case where links 32a, 32b, and 32c are connected to the intersection 33a, the estimated route generation unit 28 acquires the intersection history of the links 32b and 32c connected to the link 32a with the intersection 33a and the approach direction from the link 32a to the intersection 33a as a key, from the travel history management unit 24 through the travel history acquisition unit 25. Herein, in the acquired intersection history, when the frequency of advances of the link 32b is higher than the frequency of advances of the link 32c, the estimated route generation unit 28 traces the link 32b in Step S17.

Further, depending on an accumulation state of the travel history or the like, there may be a case where no link to be traced can be specified. In such a case, for example, a link to be traced may be specified from a road type, a contact angle of links which are acquired immediately before, or the like.

In Step S18, the estimated route generation unit 28 generates an estimated route on the basis of the link which is the traced advance destination. When Step S18 is first performed, the estimated route generation unit 28 connects the link where the subject vehicle is currently present and the link which is the advance destination tranced this time, to thereby generate the estimated route. When Step S18 is performed the second time or later, the estimated route generation unit 28 connects the link which is the advance destination traced this time to the estimated route generated until now, to thereby extend the estimated route.

In Step S19, the estimated route generation unit 28 determines whether the generated estimated route satisfies the end condition for generation of the estimated route or not. As the end condition, for example, a condition that the length of the generated estimated route is not shorter than a predetermined threshold value, or the like, is applied. When it is determined that the generated estimated route satisfies the end condition, the process shown in FIG. 4 is ended, and when it is not determined that the generated estimated route satisfies the end condition, the process goes to Step S20.

In Step S20, the estimated route generation unit 28 sets an intersection corresponding to a tip of the traced advance destination as a new starting point. In the exemplary case shown in FIG. 5, the estimated route generation unit 28 sets an intersection 33b corresponding to a tip of the link 32b which is the traced advance destination, as a new starting point.

After that, the process goes back to Step S17. As shown in FIG. 5, in the case where the links 32b, 32d, and 32e are connected to the intersection 33b, the estimated route generation unit 28 acquires the intersection history of the links 32d and 32e connected to the link 32b with the intersection 33b and the approach direction from the link 32b to the intersection 33b as a key, from the travel history management unit 24 through the travel history acquisition unit 25. Herein, in the acquired intersection history, when the frequency of advances of the link 32d is higher than that of the link 32e, the estimated route generation unit 28 traces the link 32d in Step S17. Thus, by repeating Steps S17 to S20, the estimated route generation unit 28 acquires the estimated route.

<Case Where One Estimated Destination is Acquired>

In Step S13, the operation in the case where the route destination determination unit 27 acquires one estimated destination is almost the same as that in the case, described earlier, where one estimated destination is not acquired.

When the route destination determination unit 27 acquires the estimated destination, however, in Step S17, the estimated route generation unit 28 traces the advance destination having the highest frequency of advances for the intersection which is set as the starting point in Step S16 or Step S20 among the advance destinations which the subject vehicle traveled when the subject vehicle traveled to the estimated destination in the past. In other words, among the intersection history, only the advance destination for the estimated destination acquired by the route destination determination unit 27 is used as the advance destination to be traced.

Further, in this case, as the end condition of Step S19, for example, a condition that the distance between the estimated route generated in Step S18 and the estimated destination acquired by the route destination determination unit 27 is not longer than a predetermined threshold value, in other words, that the estimated route is generated up to the vicinity of the estimated destination, or the like may be applied.

<Gist of The Second Preferred Embodiment>

In the travel route estimation apparatus 1 of the second preferred embodiment, when the route destination determination unit 27 acquires the estimated destination, since the travel route is estimated by using only the history that the subject vehicle travels to the estimated destination, among the travel history acquired by the travel history acquisition unit 25, it is possible to increase the accuracy of estimation of the travel route. Further, in the second preferred embodiment, when the route destination determination unit 27 does not acquire the estimated destination, since the travel route is estimated by using all the travel history acquired by the travel history acquisition unit 25, it is possible to achieve highly sophisticated travel support.

Furthermore, in the second preferred embodiment, the estimated destination is acquired from the candidates for the estimated destination on the basis of the respective reliabilities of the candidates for the estimated destination. When a plurality of candidates for the estimated destination are acquired, it is thereby possible to estimate the travel route which makes it possible to reach an appropriate estimated destination.

Moreover, in the second preferred embodiment, since the travel history for each intersection is used, it is possible to estimate the travel route with relatively simple operation.

<The First Variation>

In the second preferred embodiment, in Step S14 (FIG. 4), the estimated route generation unit 28 may acquire the current state information which is travel environment information from the travel environment specifying unit 22. Then, on the basis of the current state information acquired from travel environment specifying unit 22, the estimated route generation unit 28 may acquire the intersection history which is the travel history to which the past state information corresponding to the current state information is added, as the intersection history in Step S17 (FIG. 4). In other words, the travel history to be used for estimation of the travel route may be limited to the travel history which the subject vehicle traveled in the past travel environment similar to the current one. With this configuration, it can be hoped that the accuracy of estimation of the travel route may be increased.

Further, instead of limiting the travel history to be used for estimation of the travel route by the travel environment information, the data of the frequency of advances or the like may be weighted on the basis of the degree of coincidence between the current travel environment and a predetermined travel environment or a travel environment which is adjusted as appropriate.

<The Second Variation>

In the second preferred embodiment, when the route destination determination unit 27 acquires the estimated destination, on the basis of the frequency of advances for an intersection on the travel route, among the frequency of advances of the advance destination which the subject vehicle traveled when the subject vehicle traveled to the estimated destination in the past, the estimated route generation unit 28 may obtain the probability of right turn and left turn at the intersection. Similarly, when the route destination determination unit 27 does not acquire the estimated destination, on the basis of the frequency of advances for an intersection on the travel route, among all the frequencies of advances, the estimated route generation unit 28 may obtain the probability of right turn and left turn at the intersection. Further, in order to obtain the probability of right turn and left turn at the intersection on the travel route, used is the frequency of advances at the intersection, the number of advances corresponding to the frequency of advances, a value in proportion to the frequency of advances or the like, or the like.

With this configuration, in the ADAS (Advanced Driver Assistance System), it is possible to generate useful information.

<The Third Variation>

In the second preferred embodiment, instead of using the frequency of advances which is the number of times for registrations per unit time period, by using the number of advances which is the total number of times for registrations, it is also possible to produce the same effect as above. When the frequency of advances is used, however, it is possible to easily respond to the change in the lifestyle of the user such as the change of the commutation route or the like.

<Other Variations>

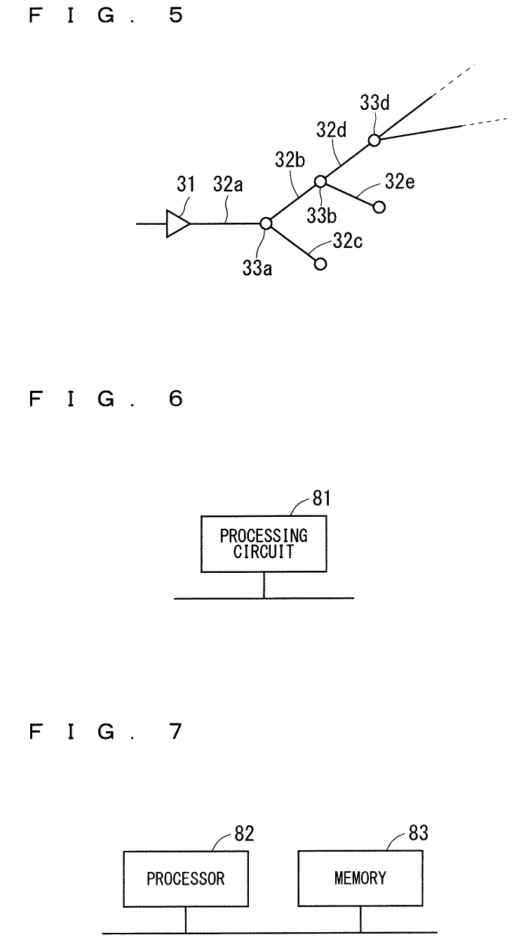

The acquisition unit 11 and the route estimation unit 12 in the above-described travel route estimation apparatus 1 will be hereinafter referred to as “the acquisition unit 11 and the like”. The acquisition unit 11 and the like are implemented by a processing circuit 81 shown in FIG. 6. Specifically, the processing circuit 81 comprises the acquisition unit 11 for acquiring an estimated destination which is estimated as a destination of a vehicle, a current position of the vehicle, and a travel history of the vehicle, and the route estimation unit 12 for estimating a travel route which the vehicle travels from the current position on the basis of the current position and the travel history acquired by the acquisition unit 11 when the acquisition unit 11 does not acquire the estimated destination. To the processing circuit 81, a dedicated hardware may be applied, or a processor which executes a program stored in a memory may be applied. As the processor, for example, used is a central processing unit (CPU), a processing unit, an arithmetic unit (AU), a microprocessor, a microcomputer, a digital signal processor (DSP), or the like.

When the processing circuit 81 is a dedicated hardware, the processing circuit 81 corresponds to, for example, a single circuit, a complex circuit, a programmed processor, a multiple programmed processor, an ASIC (Application Specific Integrated Circuit), an FPGA (Field Programmable Gate Array), or a combination of these circuits. Respective functions of the constituent elements such as the acquisition unit 11 and the like may be implemented by circuits into which the processing circuit is decentralized, or these functions may be collectively implemented by one processing circuit.

When the processing circuit 81 is a processor, the functions of the acquisition unit 11 and the like are implemented by combination with software or the like. The software or the like corresponds to, for example, software, firmware, or software and firmware. The software or the like is described as a program and stored in a memory. As shown in FIG. 7, a processor 82 applied to the processing circuit 81 reads and executes the program stored in a memory 83, to thereby implement the respective functions of the constituent elements. Specifically, the travel route estimation apparatus 1 comprises the memory 83 which stores therein programs which are executed by the processing circuit 81 to consequently perform the step in which the estimated destination which is estimated as the destination of the vehicle, the current position of the vehicle, and the travel history of the vehicle are acquired and the step in which the travel route which the vehicle travels from the current position is estimated on the basis of the current position and the travel history which are acquired when the estimated destination is not acquired. In other words, the program is executed to cause a computer to perform a procedure or a method of the acquisition unit 11 and the like. Herein, the memory 83 corresponds to, for example, a nonvolatile or volatile semiconductor memory such as a RAM (Random Access Memory), a ROM (Read Only Memory), a flash memory, an EPROM (Erasable Programmable Read Only Memory), an EEPROM (Electrically Erasable Programmable Read Only Memory), or the like, a HDD (Hard Disk Drive), a magnetic disk, a flexible disk, an optical disk, a compact disk, a mini disk, or a DVD (Digital Versatile Disc) and a drive unit thereof, or the like.

The case has been described above where the respective functions of the acquisition unit 11 and the like are implemented by one of hardware and software or the like. This is, however, only one exemplary case. There may be a case where some part of the acquisition unit 11 and the like is implemented by a dedicated hardware and the other part is implemented by software or the like. Thus, the processing circuit 81 can implement the above-described functions by hardware, software or the like, or combination thereof.

Further, the above-described travel route estimation apparatus 1 can be applied to a travel route estimation system which is a system constructed by combining, as appropriate, a navigation device such as a Portable Navigation Device, a communication terminal including a portable terminal such as a cellular phone, a smartphone, a tablet, or the like, an application function installed in these device or terminal, and a server. In this case, the functions or the constituent elements in the above-described travel route estimation apparatus may be arranged, being decentralized into these devices and terminals which constitute the system, or may be arranged, being centralized into any one device or terminal.

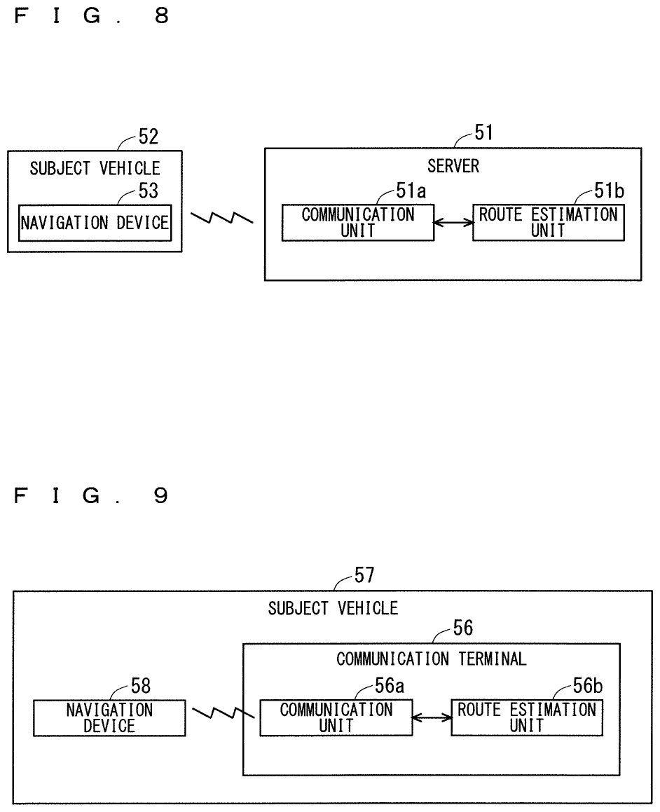

FIG. 8 is a block diagram showing a constitution of a server 51 in accordance with the present variation. The server 51 of FIG. 8 comprises a communication unit 51a and a route estimation unit 51b, and can perform wireless communication with a navigation device 53 of a subject vehicle 52.

The communication unit 51a serving as the acquisition unit performs wireless communication with the navigation device 53, to thereby receive an estimated destination acquired by the navigation device 53, a current position of the subject vehicle 52, and a travel history of the subject vehicle 52.

The route estimation unit 51b has the same function as that of the above-described route estimation unit 12 when a not-shown processor in the server 51 executes a program stored in a not-shown memory device in the server 51. Specifically, when the communication unit 51a does not acquire the estimated destination, the route estimation unit 51b estimates the travel route which the subject vehicle 52 travels from the current position on the basis of the current position and the travel history which are acquired by the communication unit 51a. Then, the communication unit 51a transfers an estimation result of the route estimation unit 51b to the navigation device 53.

By the server 51 constructed thus, for example, even when the navigation device 53 has only a display function and a communication function with the server 51, it is possible to produce the same effect as that of the travel route estimation apparatus 1 described in the first preferred embodiment.

FIG. 9 is a block diagram showing a constitution of a communication terminal 56 in accordance with the present variation. The communication terminal 56 of FIG. 9 comprises a communication unit 56a like the communication unit 51a and a route estimation unit 56b like the route estimation unit 51b, and can perform wireless communication with a navigation device 58 of a subject vehicle 57. Further, to the communication terminal 56, applied is, for example, a portable terminal such as a cellular phone, a smartphone, a tablet, or the like, which a driver of the subject vehicle 57 carries. By the communication terminal 56 constructed thus, for example, even when the navigation device 58 has only a display function and a communication function with the communication terminal 56, it is possible to produce the same effect as that of the travel route estimation apparatus 1 described in the first preferred embodiment.

In the present invention, the preferred embodiments and the variations may be freely combined, or may be changed or omitted as appropriate, without departing from the scope of the invention.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1 travel route estimation apparatus, 11 acquisition unit, 12 route estimation unit

1. A travel route estimation apparatus, comprising:
a receiver for acquiring an estimated destination which is estimated as a destination of a vehicle, a current position of the vehicle, and a travel history of the vehicle; and
a route estimator for estimating a travel route which the vehicle travels from the current position, on the basis of the current position and the travel history which are acquired by the receiver, when the receiver does not acquire the estimated destination.

2. The travel route estimation apparatus according to claim 1, wherein
when the receiver acquires the estimated destination, the route estimator estimates a travel route which the vehicle travels from the current position, on the basis of the estimated destination, the current position, and the travel history which are acquired by the receiver.

3. The travel route estimation apparatus according to claim 2, wherein
when the receiver acquires the estimated destination, the route estimator estimates the travel route by using only a history that the vehicle traveled to the estimated destination, among the travel history acquired by the receiver, and
when the receiver does not acquire the estimated destination, the route estimator estimates the travel route by using all the travel history acquired by the receiver.

4. The travel route estimation apparatus according to claim 1, wherein
the receiver further acquires a candidate for the estimated destination and reliability of the candidate for the estimated destination, and
in at least one of cases where a first reliability which is the highest reliability among reliabilities of a plurality of candidates for the estimated destination is not lower than a predetermined value and where a difference between the first reliability and a second reliability which is the second highest reliability next to the first reliability among the reliabilities of the plurality of candidates for the estimated destination is not lower than a predetermined value, the receiver acquires a candidate for the estimated destination having the first reliability as the estimated destination.

5. The travel route estimation apparatus according to claim 1, wherein
for each intersection, the travel history includes the frequency of advances or the number of advances of an advance destination to which the vehicle advanced from the intersection in the past, and
when the receiver does not acquire the estimated destination, the route estimator estimates the travel route by setting an intersection corresponding to the current position as a starting point, and by repeating tracing the advance destination which has the highest frequency of advances or the highest number of advances for the intersection set as the starting point, and setting an intersection corresponding to a tip of the advance destination as a new starting point.

6. The travel route estimation apparatus according to claim 5, wherein
when receiver acquires the estimated destination, the route estimator estimates the travel route by setting an intersection corresponding to the current position as a starting point, and by repeating tracing the advance destination which has the highest frequency of advances or the highest number of advances for the intersection set as the starting point, among the advance destinations which the vehicle traveled when the vehicle traveled to the estimated destination in the past, and setting an intersection corresponding to a tip of the advance destination as a new starting point.

7. The travel route estimation apparatus according to claim 5, wherein
when the receiver acquires the estimated destination, on the basis of the frequency of advances or the number of advances for an intersection on the travel route, among the frequencies of advances or the numbers of advances of the advance destinations which the vehicle traveled when the vehicle traveled to the estimated destination in the past, the route estimator obtains the probability of right turn and left turn at the intersection, and
when the receiver does not acquire the estimated destination, on the basis of the frequency of advances or the number of advances for an intersection on the travel route, the route estimator obtains the probability of right turn and left turn at the intersection.

8. The travel route estimation apparatus according to claim 1, wherein
past state information indicating a past travel state of the vehicle is added to the travel history,
the receiver further acquires current state information indicating a current travel state of the vehicle, and
the route estimator estimates the travel route by using the travel history to which the past state information corresponding to the current state information is added, on the basis of the current state information acquired by the receiver.

9. A travel route estimation method, comprising:
acquiring an estimated destination which is estimated as a destination of a vehicle, a current position of the vehicle, and a travel history of the vehicle; and
estimating a travel route which the vehicle travels from the current position, on the basis of the current position and the travel history which are acquired, when the estimated destination is not acquired.
